(19) United States
(12) Patent Application Publication
(10) Pub. No.: US 2017/0339342 A1
(43) Pub. Date: Nov. 23, 2017

(54) UNINTERRUPTED POWER SUPPLY APPARATUS FOR USB CAMERA

(71) Applicant: Zhongshan Dashan Photographic Equipment Co., Ltd., Zhongshan (CN)

(72) Inventor: Xihua Zhu, Zhongshan (CN)

(21) Appl. No.: 15/446,018

(22) Filed: Mar. 1, 2017

(30) Foreign Application Priority Data
Jan. 21, 2016 (CN) 201620083338.2

(51) Int. Cl. H04N 5/232; H02J 9/06

(52) U.S. Cl. CPC H04N 5/23241; H02J 9/061

(57) ABSTRACT

An uninterrupted power supply apparatus for a USB camera, including a mobile power supply, a voltage conversion circuit, and an electric energy storage device, wherein the voltage conversion circuit is respectively electrically connected to the mobile power supply and the electric energy storage device, and the voltage output terminal of the voltage conversion circuit is connected to the USB camera. The mobile power supply is capable of supplying voltage desired by the USB camera through conversion, and additionally the converted voltage is stored in the electric energy storage device to accommodate instant high power demands. Therefore, the uninterrupted power supply apparatus according to the present invention has a more reasonable structure, is capable of accommodating shooting demands by long-time supplying power, and is not subjected to the impact of the temperature.

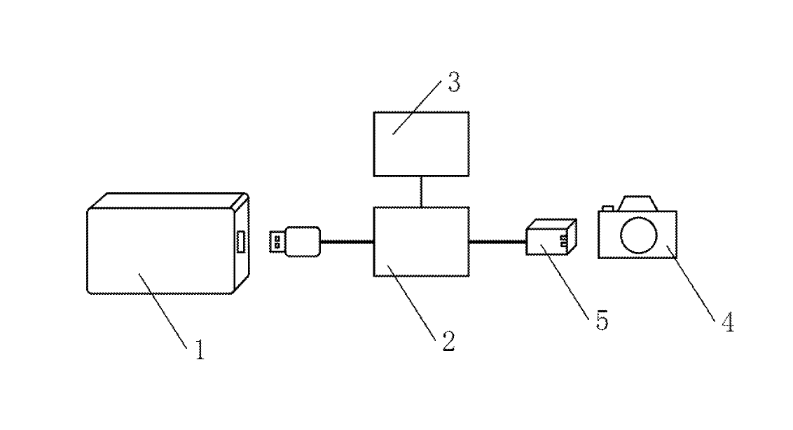

### CROSS REFERENCE TO RELATED APPLICATIONS

The present application claims the benefit of Chinese Patent Application No. 201620083338.2 filed on Jan. 21, 2016. All the above are hereby incorporated by reference.

### TECHNICAL FIELD

The present invention relates to camera peripherals, and in particular relates to an uninterrupted power supply apparatus for a USB camera.

### BACKGROUND

As well known, the batteries equipped in most cameras are very limited in durability. With respect to the scenario of long-time picking up videos pictures, the battery of the camera is insufficient in endurance. However, frequent replacement of the battery would affect use of the camera. In addition, high temperatures and low temperatures also affect the performance of the battery of the camera. For example, in winter, if the temperature is lower than 0° C., the performance of the lithium battery would be greatly reduced, or even the battery fails to output a current to supply power. However, the user may not place the battery or camera into the arms for preserving heat while using. Therefore, at present, the endurance of the lithium battery is very limited, which affect normal use of the camera. In addition, the lithium battery is greatly subjected to temperatures, and thus the lithium battery is applicable to limited scenarios.

### SUMMARY

To overcome the defect in the related art, the present invention is intended to provide an uninterrupted power supply apparatus for a USB camera, which is more reasonable in structure and capable of accommodating shooting demands by long-time supplying power, is not subjected to the impact of the temperature, and may be applicable to more scenarios.

To solve the above technical problem, the present invention employs the following technical solution:

An uninterrupted power supply apparatus for a USB camera is provided. The apparatus comprises a mobile power supply, a voltage conversion circuit, and an electric energy storage device, wherein the voltage conversion circuit is respectively electrically connected to the mobile power supply and the electric energy storage device, and a voltage output terminal of the voltage conversion circuit is connected to the USB camera.

In an improved technical solution of the uninterrupted power supply apparatus for a USB camera, the voltage output terminal of the voltage conversion circuit is connected to the USB camera via a fake camera power supply battery.

In an improved technical solution of the uninterrupted power supply apparatus for a USB camera, the voltage conversion circuit is connected to the mobile power supply via a USB interface.

In an improved technical solution of the uninterrupted power supply apparatus for a USB camera, the electric energy storage device is a supercapacitor, an accumulator battery, or a rechargeable battery.

The electric energy storage device can take the operation of charge or discharge by means of a USB power supply under the control of a control unit, and is compatible with a voltage such as 5V, and 9V, 12V under Quick Charge standard, so as to achieve more effective use of electric energy, be capable of inputting higher instant power, have longer and more stable application effect. The electric energy storage device can have various capacities based on the needed load, it can store electric energy varies from several joules to hundreds of joules, so as to configure better experience for personal use.

The voltage conversion circuit employs DC buck-boost technique, it converts the electric energy provided with USB to a certain voltage (4.2 V, 8.4 V or the like) required by the camera. By means of a voltage conversion chip with buck-boost or boost technique, the power supply conversion efficiency can be 90% or more. The electric energy can be output to a device such as a camera after the voltage conversion is performed.

As compared with the related art, the present invention achieves the following beneficial effects: Since the uninterrupted power supply apparatus for a USB camera comprises a mobile power supply, a voltage conversion circuit, and an electric energy storage device, the mobile power supply is capable of supplying voltage desired by the USB camera through conversion, and additionally the converted voltage is stored in the electric energy storage device to accommodate instant high power demands. In this way, on the premise of satisfying long-time shooting demands, even at low temperatures, heat preservation may be singly implemented for the USB mobile power supply, thereby achieving shooting while preserving heat. Therefore, the uninterrupted power supply apparatus according to the present invention has a more reasonable structure, is capable of accommodating shooting demands by long-time supplying power, and is not subjected to the impact of the temperature.

The present invention is described in detail with reference to attached drawings and exemplary embodiments.

### BRIEF DESCRIPTION OF THE DRAWING

The figure is a schematic diagram illustrating principles of an uninterrupted power supply apparatus for a USB camera according to an embodiment of the present disclosure.

### DETAILED DESCRIPTION

The present invention provides an uninterrupted power supply apparatus for a USB camera. As illustrated in the figure, the apparatus comprises a mobile power supply 1 providing 5 V or higher voltage, a voltage conversion circuit 2, and an electric energy storage device 3, wherein the voltage conversion circuit 2 is respectively electrically connected to the mobile power supply 1 and the electric energy storage device 3, and the voltage output terminal of the voltage conversion circuit 2 is connected to the camera 4.

The function of the voltage conversion circuit 2 is to convert an input voltage of the mobile power supply providing 5 V or higher voltages into 3.4 V or 7.4 V. This is because the USB mobile power supply is capable of uninterruptedly supplying power to such devices as mobile phones. Considering that the camera generally uses one or two lithium batteries, which provide a voltage of 3.7 V or 7.4 V, and the USB needs a voltage of 5 V or higher volt. To this end, according to the present invention, the voltage conversion circuit is employed to provide the USB mobile power supply to the camera.

The function of the electric energy storage device 3 is to store the electric energy to accommodate instant high power demands since the camera needs a great current at the instant of shooting.

Through practice, use of the USB mobile power supply may greatly enhance the endurance of the camera. For example, a 1000 mAh mobile power supply is capable of providing endurance of 3 to 5 original camera batteries, such that the long-time shooting demands are satisfied. Further, even in case of low temperatures, heat preservation may be singly achieved for the USB mobile power supply, and thus the camera may be used for shooting while being subjected to heat preservation. In this way, the camera is not subjected to impacts of the temperature, and is hence applicable to more scenarios. Therefore, the uninterrupted power supply apparatus according to the present invention has a more reasonable structure, is capable of accommodating shooting demands by long-time supplying power, and is not subjected to the impact of the temperature.

To ensure that the voltage output terminal of the voltage conversion circuit 2 is more conveniently and quickly connected to the camera 4 while making no changes to the camera, the voltage output terminal of the voltage conversion circuit 2 is connected to the camera via a fake camera power supply battery 5 (that is, by using the battery shell and a conduction contact of the shell). In this way, during the use, the fake camera power supply battery 5 is mounted in a battery slot of the camera, and then the camera is electrically conducted.

The electric energy storage device 3 may be a supercapacitor, an accumulator battery, a rechargeable battery or the like.

Preferably, the voltage conversion circuit 2 may be connected to the mobile power supply 1 via a USB interface.

Detailed above is merely a preferred embodiment of the present invention, and is not intended to limit the scope of the present invention. Any equivalent variation and polishment made based on the disclosure of the present invention shall fall within the protection scope of the present invention.

What is claimed is:

1. An uninterrupted power supply apparatus for a USB camera comprising a mobile power supply, a voltage conversion circuit, and an electric energy storage device, wherein the voltage conversion circuit is respectively electrically connected to the mobile power supply and the electric energy storage device, and a voltage output terminal of the voltage conversion circuit is connected to the USB camera.

2. The uninterrupted power supply apparatus according to claim 1, wherein the voltage output terminal of the voltage conversion circuit is connected to the USB camera via a fake camera power supply battery.

3. The uninterrupted power supply apparatus according to claim 1, wherein the voltage conversion circuit is connected to the mobile power supply via a USB interface.

4. The uninterrupted power supply apparatus according to claim 3, wherein the electric energy storage device is a supercapacitor, an accumulator battery, or a rechargeable battery.
